(19) United States
(12) Patent Application Publication
(10) Pub. No.: US 2005/0242518 A1
(43) Pub. Date: Nov. 3, 2005

(54) Slide ring seal

(76) Inventors: Christopher Mark Rippl, Wetzlar (DE); Ronald Sachs, Dortmund (DE); Juergen Wagner, Mueschenbach (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/116,071

(22) Filed: Apr. 27, 2005

(30) Foreign Application Priority Data
Apr. 30, 2004 (DE) 10 2004 021 502.2

(51) Int. Cl. F16J 15/34

(52) U.S. Cl. 277/399

(57) ABSTRACT

A slide ring seal for sealing a rotatable shaft includes a non-rotating slide ring formed as a cylinder having a variable inner diameter that defines a profile forming a cross-section of the slide ring and corresponding to a matching profile of the shaft for engagement therewith.

### BACKGROUND OF THE INVENTION

1. Field of the Invention

The present invention relates to a slide ring seal for sealing a rotatable shaft and including a non-rotating slide ring. The present invention also relates to a non-rotating method of mounting of the slide ring of a slide ring seal on the rotatable shaft.

2. Description of the Prior Art

In many cases, slide ring seals must be used for sealing rotatable shafts. E.g., at high pressure differences across the seal, when only a small leakage must be insured, at high environmental temperatures and high circumferential speeds, it is necessary to use slide ring seals for sealing the rotatable shafts. According to the state of the art, the basic structure of such seals consists of two annular or ring-shaped parts of which one is mounted on the rotatable shaft and the other one is mounted in a housing section that surrounds the shaft. The end surfaces of the two parts, which are made as smooth as possible, are close-fitted with each other, with a so-called sealing clearance formed therebetween. As narrow as possible sealing clearance provides for a best sealing effect. In practice, the width of a sealing clearance amounts to several microns. In principle, the difference between radial and axial seals is defined by the orientation of the sealing clearance. In axial seals, the sealing clearance extends in a radial direction, and in radial seals, the sealing clearance extends in an axial direction. The sealing effect depends more on the clearance width than the clearance length. In axial seals, the clearance width is more easily controlled. In particular, in axial seals, a more narrow clearance can be achieved than in radial seals. Therefore, the axial slide ring seals are used more widely (see Miiller, Nau, Handbook of Sealing Technology).

In order to insure a sealing effect an axial force should press the stationary and rotatable slide rings against each other. German Patent DE-PS 37 40 694 discloses a slide ring seal in which the axial force is generated by a spring.

In order to retain the slide rings on the shaft and in the housing and, simultaneously, to obtain a good sealing, other components are necessary. As a retaining component an elastomeric component, which is expensive to produce, can be used. An elastomeric component having a special shape in order to be able to withstand the required medium and high pressure differences is disclosed in German Patent DE-PS 41 15 155.

An important fact is the selection of a material of the slide ring. When selecting a material of a slide ring, tribological considerations have to be considered. In addition the temperature stability and the surface quality are important considerations.

German Publication DE-05 100 56 102 discloses adaptation of a slide ring to special condition by selection of an appropriate material (in this case, of silicon carbide and carbon-silicon carbide composition).

Slide rings of the state of the art include a large number of separate components which should be combined with each other to form a seal. This requires large volumes as the total ratio of a sealing surface and the required volume is unfavorable. The excess volume complicates mounting of the slide rings in apparatuses and machines where often a compact mass with a maximum sealing effect is required. The large number of parts makes their manufacture and mounting time-consuming and expensive.

Because of the friction between the slide rings and insignificant cooling, a large amount of heat is generated. The heat should be removed in a controlled manner. In Japanese Publication JP-1120486, this problem is solved by selection of the material of the slide ring. However, this solution is not always applicable. When the above-discussed slide ring seals are used in dynamical or positive-displacement machines for treating reactive gases, some components of the seal can have a small resistance against the reactive gas loads, and the adaptation of the seals becomes difficult.

It is known to cut a slide ring with a saw in three or more ring segments and then suitable ring segments are joined together, e.g., by using a spring tension ring or placing the segments in a suitable metal mounting. When a ring is cut with saw, some amount of ring material is removed. Therefore, it is not any more possible to form a full circle of ring segments which are formed by cutting a slide ring blank. Therefore, to produce a slide ring, ring segments of several blanks are used or, alternatively, the segments are subjected to an appropriate treatment. In both cases, the manufacturing costs increase.

Accordingly, an object of the invention is to provide a slide ring seal as compact as possible and which, at the same time, would insure the best possible sealing effect.

### SUMMARY OF THE INVENTION

This and other objects of the present invention, which will become apparent hereinafter, are achieved according to the invention by providing a non-rotating slide ring formed as a cylinder having a variable inner diameter that defines a profile forming a cross-section of the slide ring and corresponding to a matching profile of the shaft for engagement therewith, and by providing a method of mounting the slide ring on the shaft and which includes breaking the slide ring at least in two parts, mounting the at least two parts about the shaft, and securing the at least two parts from separation from each other.

A slide ring seal according to the present invention insures a very high tightness with as few components as possible and with using a minimal volume. The construction of the seal is noticeably simplified in comparison with those of the state of the art, which noticeably reduces manufacturing, mounting and maintenance costs. The materials, which are used for forming the slide rings, permit the use of the inventive slide ring seal in a harmful environment, e.g., in dynamic or positive displacement machines for delivery of reactive gases. For selection of the materials of the slide rings, in addition to consideration of tribological characteristics, a requirement that the used materials had as small plastic deformation as possible during breaking also should be taken into consideration. In addition, with a slide ring seal according to the present invention, the influence of the thermal effect, which is produced during the operation of a machine the inventive slide ring seal is used in, in particular, the influence of the material expansion is reduced to a minimum. The seal has a very small harmful volume which permits to use the seal in machine in which the harmful volume is critical, e.g., in vacuum pumps. In vacuum pumps, in particular, the shock pressure resistance plays an increased role. The advantage of the inventive slide ring seal also consists in that it can well withstand shock pressures. The inventive slide seal ring has an increased service life because the load is distributed over several surfaces. Therefore, the pressure of the surfaces against each other which is generated upon application of axial forces is reduced, whereby the abrasion is also reduced. The axial forces can be obtained in different ways, e.g., by using a spring, pressure difference between sealed from each other chambers, or an elastomeric ring. By proper selection of the number of sealing surfaces, operational and sealing characteristics can be optimized.

According to the method of the present invention, the parts after being mounted on the shaft, are pressed against each other with suitable retaining means, and the shaft, together with the slide ring mounted thereon, is mounted in the machine housing. Because breaking is not accompanied by removal of material from break surfaces, the separate ring segments can be again joined together, without any additional treatment. The surfaces are not smooth but are rather irregular. Therefore, the slide ring, which is formed of broken parts is those tight than a ring formed sawed parts. The inventive method insures easy mounting and dismounting of seal and does not produce any refuse as all of the broken ring segments are used. Thereby, the costs of the rings is reduced. Simultaneously, the replacement of a defective seal is noticeably simplified, which also reduces the costs.

The combination of the inventive slide ring and the inventive method permits mounting of the seal at arbitrary locations, which makes forming of, e.g., undercuts possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective view of a slide ring seal according to the present invention with a variable inner diameter and which is mounted between a rotatable shaft and a housing;

FIG. 2 a cross-sectional view illustrating mounting of the slide ring seal according to the present invention in a vacuum pump;

FIG. 3 a cross-sectional view illustrating different profiles of an inner contour of a slide ring according to the present invention;

FIG. 4 a cross-sectional view illustrating a slide ring seal according to the present invention and formed of several segments;

FIG. 5 a perspective view of a slide ring seal according to the present invention illustrating the structure of the sealing surfaces; and

FIG. 6 a perspective view illustrating mounting of seal ring according to the present invention.

### DETAILED DESCRIPTION OF THE PREFERRED EMBODIMENT

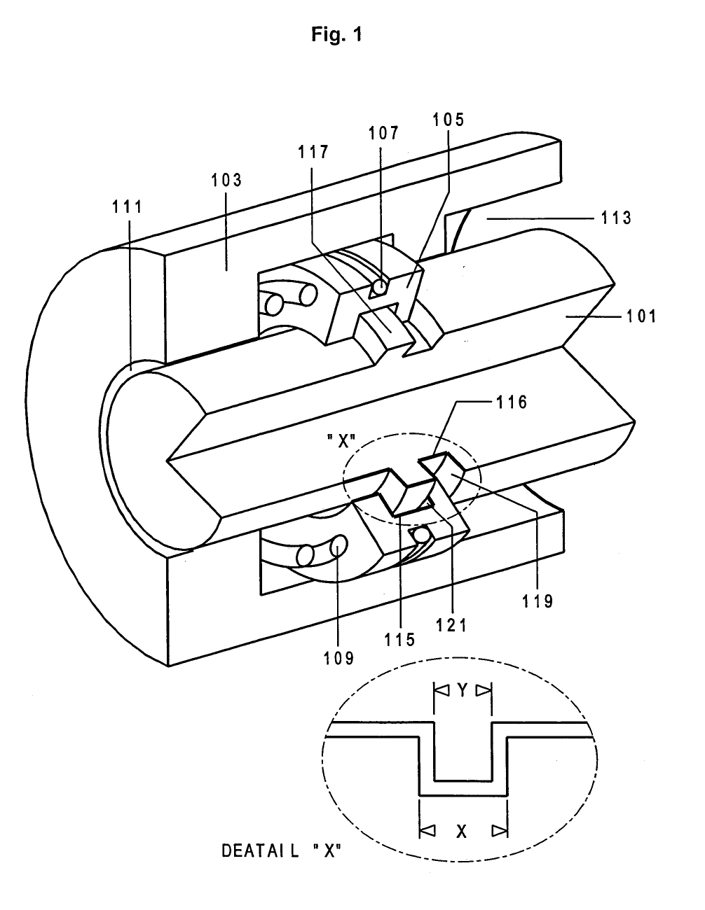

A slide ring seal according to the present invention, which is shown in FIG. 1, includes a slide ring 105 that is arranged between a rotatable shaft 101 and a housing 103. The sliding ring 105 is held in place by an elastomeric ring 107. The slide ring seal seals chambers 111 and 113 from each other. A spring 109 applies to the slide ring 105 a force directed rightwardly in FIG. 1. The slide ring 105 has a variable inner diameter that defines a profile 115. The rotatable part, the shaft 101, has a matching profile 116, with the slide ring profile 115 and the shaft profile 116 engaging with each other. This is achieved, e.g., with a shaft element 117 engaging in the slide ring 105, as shown in FIG. 1. While in FIG. 1, the shaft element 117 is shown as an integral part of the shaft 101, it can constitute a component of a separate part mounted on the shaft 101. Axial forces that act on the slide ring 105, press the slide ring 105 against radial surfaces 119, with a clearance being formed therebetween. A surface, a surface normal of which extends parallel to the shaft axis, is designated as a radial surface.

The radial surfaces are formed of a material which is selected based on tribological considerations. In the embodiment considered here, this material is steel. The slide ring 105 is formed of carbon, ceramics, or other breakable material. Because the shaft 101 has the shaft element 117 projecting into the slide ring 105, the ring 105 cannot be pushed onto the shaft 101. Therefore, the slide ring 105, in accordance with the inventive method, is broken into several ring pieces. These pieces are then arranged about the shaft 101. Thereafter, the elastomeric ring 107 is pushed over the mounted ring pieces, e.g., two, holding them together. Dependent on the requirements, the ring pieces can be glued with each other at the breaking surfaces with a suitable glue, which further increases the sealing effect. The rubbed-off material, which is formed on the inner surfaces of the slide ring during functioning of the seal, accumulates in chamber 121.

Frictional forces, which act between the slide ring 105 and radial surfaces 119 generate heat that causes increase in temperature and a resulting longitudinal expansion of the element 117 of the shaft 101. The longitudinal expansions of the shaft 101 and the slide ring 105, which is caused by existing thermal condition, because of the difference in materials the shaft 101 and the slide ring 105 are made of, are not the same. As a result, the axial clearance between the shaft element 117 and the slide ring profile 115 is reduced. The thermal expansion should not lead to the reduction of the sealing clearance or to a run-on of the parts at both sides. Therefore, the thermal expansion should be taken into consideration. Accordingly, the width y of the shaft element 117 and the size x of the recess of the profile 115 are so selected that the difference therebetween is larger than the longitudinal expansion at a maximal temperature that is expected during operation.

The distance of the radial surfaces 119 from each other can be maintained during the manufacturing process only to a limited extent. However, this does not present a problem for the slide ring according to the present invention because during a short, in comparison with their service life, response time, self-optimization takes place. At the start of the operation, a sealing clearance is formed only on one of the surfaces. At this surface, in this phase of the operation, abrasion is increased because of high forces acting on the slide ring. Therefore, an excessive amount of material is removed. In a short while, the slide ring becomes adapted to the shape of the radial surfaces 119 and to the distance therebetween.

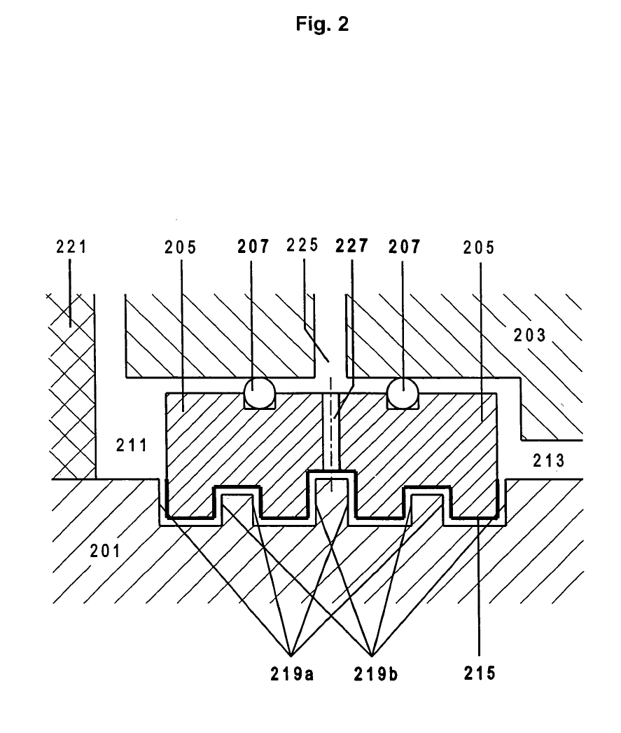

FIG. 2 shows the use of the inventive slide ring seal in a vacuum pump, e.g., in a two-shaft positive displacement pump. The shaft 201 of the pump supports a rotary piston 221 which is arranged in the housing 203. In the pump, the compression/expansion chamber 211 should be sealed from the chamber 213 in which the drive is located. A symmetrical slide ring 205 is arranged between the shaft 201 and the housing 203. The slide ring 205 is held in the housing 203 with an elastomeric ring 207. The slide ring 205 has a variable inner diameter that defines the profile 215. The axial force can bias the slide ring 205 against the surfaces 219a or 219b, dependent on the direction in which the force acts. In the embodiment, shown in FIG. 2, this force is produced by a pressure difference of pressures prevailing in the drive chamber 213 and the compression/expansion chamber 211, with vacuum prevailing in the compression/expansion chamber 211 and with the drive chamber 213 being under pressure which is slightly below the atmospheric pressure. When the pressures in the chambers 211 and 213 are reversed, the seal still functions adequately because of its symmetricity. With a reversed pressure ratio, the force acts, in the plane of the drawing, rightwardly, with the sealing effect being applied to the surfaces 219b. Furthermore, the symmetrical mounting of the seal ring 205 is facilitated by the fact that no predetermined orientation should be observed.

The sealing effect of the slide ring according to the present invention is noticeably improved in comparison with the slide ring seals of the state of the art because more sealing surfaces act simultaneously in a compact space. Therefore, the pressure drop across separate surfaces is respectively smaller than in case of a single sealing surface. The formation of the profile insures a labyrinth-like sealing.

Dependent on the application, subjecting the seal to the action of a seal gas may be desirable. To this end, there is provided a bore 225 in the housing 203 and a bore 227 in the slide ring 205 itself. Alternatively, it is possible to form the slide ring of a porous material, so that the seal gas can penetrate through the pores of the slide ring. Still further, it is possible to use two slide rings according to the present invention arranged axially one after another and axially spaced from each other, with the seal gas being introduced into the gap between the two slide rings.

For manufacturing of slide rings, particularly for use in vacuum pumps, an electrographitized artificial carbon is used. The use of this material provides for adaptation to high environmental temperatures. The maximal compatible environmental temperature then would depend only on the material of the static seal 207.

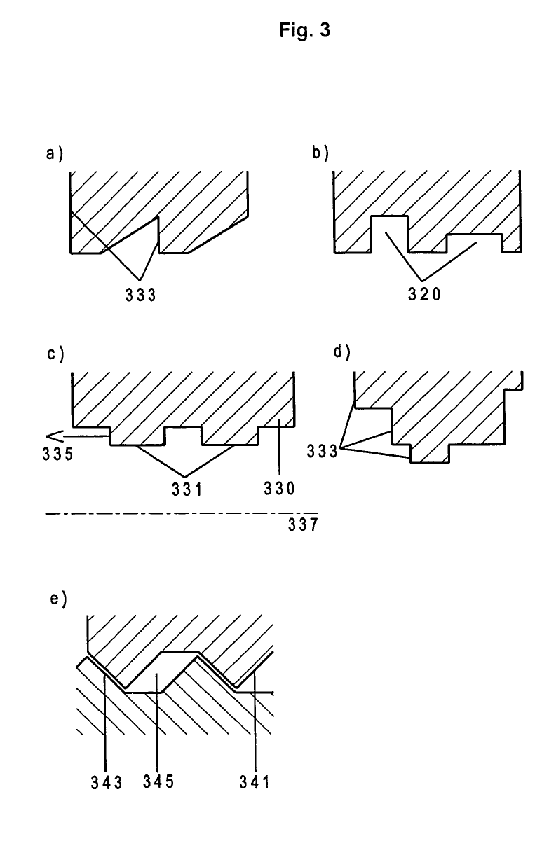

The profiles (115, 215) are not limited to those described above. Other possible profiles are shown in FIG. 3. E.g., a saw-tooth-shaped profile shown in FIG. 3a also can be used. It is also possible to form the recesses 320 with different depths or width, as shown in FIG. 3b. It is further possible to form the recesses without increase in radius (FIG. 3c). Rather, the radius of the slide ring 330 is reduced at locations 331.

Advantageously, the profile includes radial surfaces 333 (FIG. 3d), i.e., surfaces the normals 335 of which extend parallel to the shaft axis 337.

An inventive effect is also achieved with the profile shown in FIG. 3d and formed as a step-shaped profile. With the profile of FIG. 3d, separate steps act as separate seal surfaces.

The profile, which is defined by the inner diameter of the slide ring, can also so be formed that the sealing effect is achieved with the axial force acting in both of opposite axial directions. Also, a saw tooth-shaped profile 341, which is shown in FIG. 3e and which engages a saw-tooth matching profile 343, is one of possible embodiments implementing the inventive idea. When the saw-tooth shape is selected, the thermal expansion of the components should be taken into account, and care should be taken to provide a corresponding free space 345.

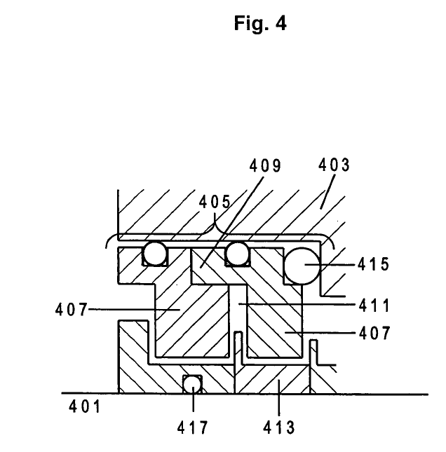

A slide ring with a variable inner diameter according to the present invention can be also formed as shown in FIG. 4. In the embodiment shown in FIG. 4, the slide ring 405 is formed of several, preferably but not necessarily identical, segments 407 which are oriented relative to each other by axial projections 409. Sections of a ring 413, which is pushed over a shaft 401, engage in recesses 411. An elastomeric ring 415 seals the ring 405 against a housing 403. The sections of the ring 413 are sealed against the shaft 401 with seal rings 417 such as, e.g., elastomeric rings. The axial forces in such a slide ring can be generated by the elastomeric ring, a spring, or by a pressure difference of the chambers which are to-be-sealed from each other. This embodiment likewise provides a compact structure with a high sealing effect.

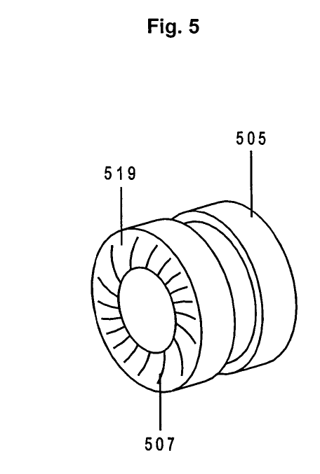

A further advantageous embodiment of a slide ring seal according to the present invention is shown in FIG. 5. In the embodiment shown in FIG. 5, sealing surfaces 519 of a slide ring seal 505, which extend transverse to the rotational axis, are provided with flutes 507. The flutes 507 increase the sealing clearance and thereby reduce the wear. The flutes or grooves can also be provided in seals discussed above. Particularly advantageously, the flutes or grooves can be provided on symmetrical rings on both sides of the seal, whereby they provide for self-centering of the seal. They also provide for a high circumferential speed.

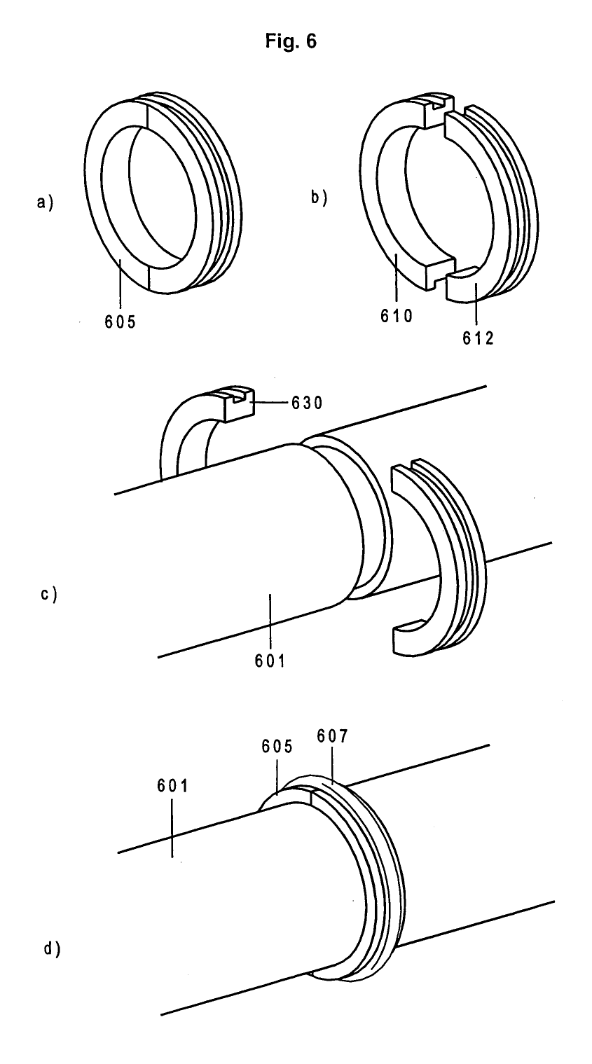

FIG. 6 illustrates a method of mounting of a slide ring 605 according to the present invention. FIG. 6a shows a slide ring 605 before mounting it on a shaft. On an end surface of the ring 605, predetermined breaking points can be provided. To this end, at predetermined locations, the end surface is slightly slit or sawed. In a further step, the slide ring 605 is purposely broken, and two halves 610 and 612 are produced, as shown in FIG. 6b. Then, the two ring halves 610 and 612 are mounted on shaft 601, as shown in FIG. 6c, with the break surfaces abutting each other. Finally, the two halves 610 and 612 are secured against separation, e.g., by an elastomeric ring 607, as shown in FIG. 6d. Advantageously, the break surfaces 630 of the two ring halves 610 and 612 are glued with a suitable glue, whereby an additional sealing effect is achieved.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. A slide ring seal for sealing a rotatable shaft, comprising a non-rotating slide ring formed as a cylinder having a variable inner diameter that defines a profile forming a cross-section of the slide ring and corresponding to a matching profile of the shaft for engagement therewith.

2. A slide ring seal according to claim 1, wherein the profile has at least two radial surfaces.

3. A slide ring seal according to claim 1, further comprising an elastomeric ring for applying an axial force to the slide ring.

4. A slide ring seal according to claim 1, further comprising a spring for applying an axial force to the slide ring.

5. A slide ring seal according to claim 1, wherein an axial force applied to the slide ring is produced by a pressure difference between two chambers to-be-sealed from each other.

6. A slide ring seal according to claim 1, wherein the profile has a shape that provides for a sealing effect for both direction of an axial force applied to the slide ring.

7. A slide ring seal according to claim 1, wherein the matching profile of the rotatable shaft is formed by an outer element of a cross-section of a separate component provided on the rotatable shaft.

8. A slide ring seal according to claim 1, wherein the slide ring is supported in a housing, and wherein both the housing and the slide ring are provided with bores for applying a seal gas.

9. A slide ring seal according to claim 1, wherein the slide ring is formed of a porous material.

10. A method of mounting a slide ring of a slide ring seal on a rotatable shaft, which slide ring is formed as a cylinder having a variable inner diameter that defines a profile forming a cross-section of the slide ring and corresponding to a matching profile of the shaft for engagement therewith, the method comprising the steps of breaking the slide ring at least in two parts, mounting the at least two parts about the shaft, and securing the at least two parts from separation from each other.

11. A method according to claim 10, wherein the securing step comprises securing the at least two parts with each other by an elastomeric ring.

12. A method according to claim 10, wherein the securing step comprises gluing of break surfaces of at least two parts to each other.

13. A vacuum pump, comprising a shaft; and a slide ring seal for sealing the shaft and having a non-rotating slide ring formed as a cylinder having a variable inner diameter that defines a profile forming a cross-section of the slide ring and corresponding to a matching profile of the shaft for engagement therewith.
